(19) United States
(12) Patent Application Publication
(10) Pub. No.: US 2003/0174348 A1
(43) Pub. Date: Sep. 18, 2003

(54) Printer

(76) Inventor: Yuji Kawase, Matsumoto-shi (JP)

Correspondence Address: EPSON RESEARCH AND DEVELOPMENT INC, INTELLECTUAL PROPERTY DEPT, 150 RIVER OAKS PARKWAY, SUITE 225, SAN JOSE, CA, 95134, US

(21) Appl. No.: 10/360,677

(22) Filed: Feb. 7, 2003

(30) Foreign Application Priority Data
Feb. 7, 2002 (JP) 2002-031454

(51) Int. Cl. G06F 15/00; B41J 1/00

(52) U.S. Cl. 358/1.8; 358/1.4

(57) ABSTRACT

A control means reduces the change in a main scanning speed when going from one line to the next in a printer using an in-line print head. This may be accomplished by using division driving to drive the print elements so that the drive current is equal to or below a specified level, and/or determining the number of print element blocks per line and adjusting the main scanning speed on a per line basis for printing. This reduces the maximum drive current required to drive a printing operation without noticeably reducing the printing speed of the printer, and further effectively reduces printing irregularities associated with division driving of print elements.

### BACKGROUND OF THE INVENTION

1. Field of the Invention

The present invention relates generally to a line printer using an in-line print head, and more specifically to technology for division driving the print elements and reducing the maximum drive current.

2. Description of the Related Art

Line printers print a two-dimensional image on paper or other recording medium transported in a main scanning direction by printing line images in a sub-scanning direction (i.e. direction typically perpendicular to the main scanning directions). The line images are printed using an in-line print head having many print elements disposed in a line. Print elements that correspond to dot locations of a specific color (e.g., black dots) in the line image to be printed are energized and driven simultaneously.

While the drive current needed to print a line image differs in each line according to the specific dot pattern printed in that line image, the number of simultaneously driven print elements is higher in lines with many driven color dots, and printing such line images therefore requires more drive current. A printer using an in-line print head with 612 print elements, for example, can print a solid line by simultaneously driving all 612 print elements to print a dot on the same line, and therefore requires a power supply with current capacity sufficient to simultaneously drive all 612 print elements. The drawback is that a high capacity power supply increases printer cost.

One way to reduce the maximum drive current required by the print head is the so-called division driving method. This technique divides the print elements into multiple blocks and separately energizes the blocks on a time division basis. Because only those print elements in any one block are energized at the same time, the maximum required drive current is reduced according to the number of print element blocks. For example, dividing the print elements into four blocks reduces the maximum drive current to ¼ that required to drive all print elements concurrently.

While division driving of the print elements reduces the maximum drive current, the time required to print one line increases accordingly. The need to suppress the maximum drive current, however, occurs only on lines having a large number of driven color dots. If the same division drive is applied even to line images containing few driven color dots, the paper feed rate, that is, the main scanning speed, must be decreased an amount corresponding to the increase in the line printing time caused by division drive. This greatly reduces the printing speed of the printer. Therefore, to avoid this drop in the printing speed the number of print element blocks is determined according to the number of driven color dots in each line image, and the main scanning speed is determined according to the number of blocks.

The speed of the paper can thus change suddenly between lines in a printer such as described above because the number of driven print element blocks and the main scanning speed are determined line by line. These sudden changes in speed can become a cause of irregular printing. If the main scanning speed changes frequently during a printing operation that should be continuous and free of such changes, such printing irregularities can become pronounced. In other words, a problem with this conventional division drive method whereby the number of driven print element blocks and the main scanning speed are set line by line is that printing irregularities occur easily.

### OBJECT OF THE INVENTION

The present invention is directed to solving this problem, and an object of the invention is to reduce the maximum drive current required to drive printing without particularly reducing the printing speed of the printer, and to effectively reduce printing irregularities in conjunction with division drive of the print elements in a printer that uses an in-line print head, division drives the print elements so that the drive current is equal to or below a specified level, and determines the number of drive divisions and the main scanning speed on a per line basis to print.

### SUMMARY OF THE INVENTION

To solve this problem, the present invention provides a control means for levelling the change in the main scanning speed in a printer that uses an in-line print head, division driving the print elements so that the drive current is equal to or below a specified level, and determining the number of drive divisions and the main scanning speed on a per line basis to print. This makes it possible to reduce the maximum drive current required to drive printing without particularly reducing the printing speed of the printer, and to effectively reduce printing irregularities in conjunction with division drive of the print elements.

Levelling is achieved by (1) controlling the change in the number of print element blocks to be driven on a time division basis, or (2) temporarily independently controlling the change in main scanning speed from the change in the number of blocks within a printing speed range determined by the number ofblocks.

This levelling control process can be performed efficiently by adding the number of blocks (determined from the drive divisions) in each line to plural lines of image data waiting in an image buffer for printing.

Other objects and attainments together with a fuller understanding of the invention will become apparent and appreciated by referring to the following description and claims taken in conjunction with the accompanying drawings.

### BRIEF DESCRIPTION OF THE DRAWINGS

In the drawings wherein like reference symbols refer to like parts.

FIG. 1 is a function block diagram of a printer according to a first embodiment of the invention.

FIGS. 2a to 2c describe the operation of the first embodiment of the invention.

FIGS. 3a to 3c describe the operation of a second embodiment of the invention.

### DESCRIPTION OF THE PREFERRED EMBODIMENTS

Embodiment 1

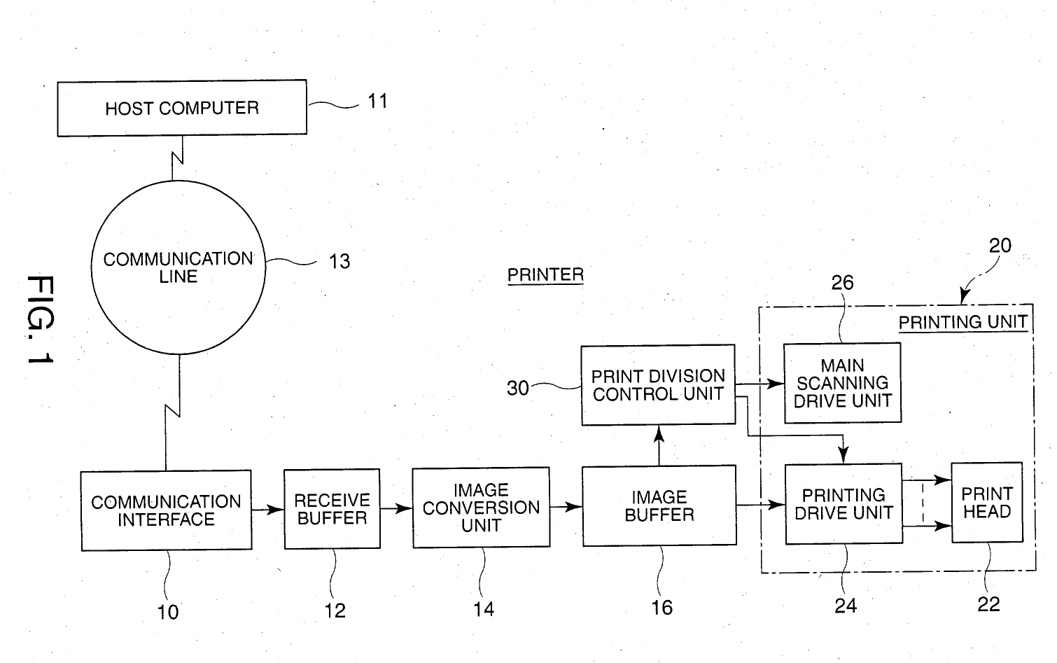

FIG. 1 is a function block diagram of a first embodiment of a printer according to the present invention. The function block diagram shown in FIG. 1 is of a line printer using an in-line print head, and includes a communication interface 10, a receive buffer 12, an image conversion unit 14, an image buffer 16, a printing unit 20, and a print division control unit 30.

The communication interface 10 receives print data from a host computer 11 via public communication network and/or LAN or other communication line 13. The received print data is temporarily stored in receive buffer 12. This print data is not image data for printing, but rather is a data stream encoding information for generating the printing image data according to a predefined format.

Print data stored in receive buffer 12 is read sequentially and transferred to image conversion unit 14. The image conversion unit 14 decodes the print data and composes image data for printing. This printing image data is stored temporarily in image buffer 16, and is then sent line by line to the printing unit 20 and printed. The image buffer 16 temporarily stores, i.e. buffers, plural lines of image data waiting to be printed.

The printing unit 20 has a print head 22, printing drive unit 24, and main scanning drive unit 26. A number of print elements (preferably equivalent to the number of dots in one line image) is arranged in a line in the sub-scanning direction on the print head 22. The printing drive unit 24 prints a line image onto the recording medium (i.e. paper below) by selectively energizing the print elements according to the dot pattern to be printed. The main scanning drive unit 26 transports the paper in the main scanning direction synchronized to the line image printing operation.

The print division control unit 30 controls levelling changes in the main scanning speed while simultaneously division driving the print elements so that the print element drive current is less than, or equal to, a specified maximum drive current and variably setting the paper feed rate, that is, the main scanning speed, based on the number of print element blocks. As part of this division drive process, the print division control unit 30 sets the number of print element blocks for each line. The main scanning speed is set line by line based on the number of blocks, but is also levelled so that the main scanning speed does not change suddenly from one line to the next.

More specifically, the number of print element blocks is variably set on a per line basis based on the number of driven color dots in each line, but if the change in the main scanning speed exceeds a specified range due to the change in the number of print element blocks, a levelling process is applied to limit the change in the main scanning speed.

This levelling process evaluates the change in the variably set number of print element blocks. This can be accomplished easily and efficiently by adding information denoting the number of blocks in each line to the image data for each line stored in image buffer 16. This added data (i.e., the number of print element blocks per line) is determined when generating the image data from the print data, or by the printer control software of the host computer.

The image conversion unit 14, print division control unit 30, and other components may be software constructions run by a microprocessor, or implemented in a dedicated asic or programmable logic device.

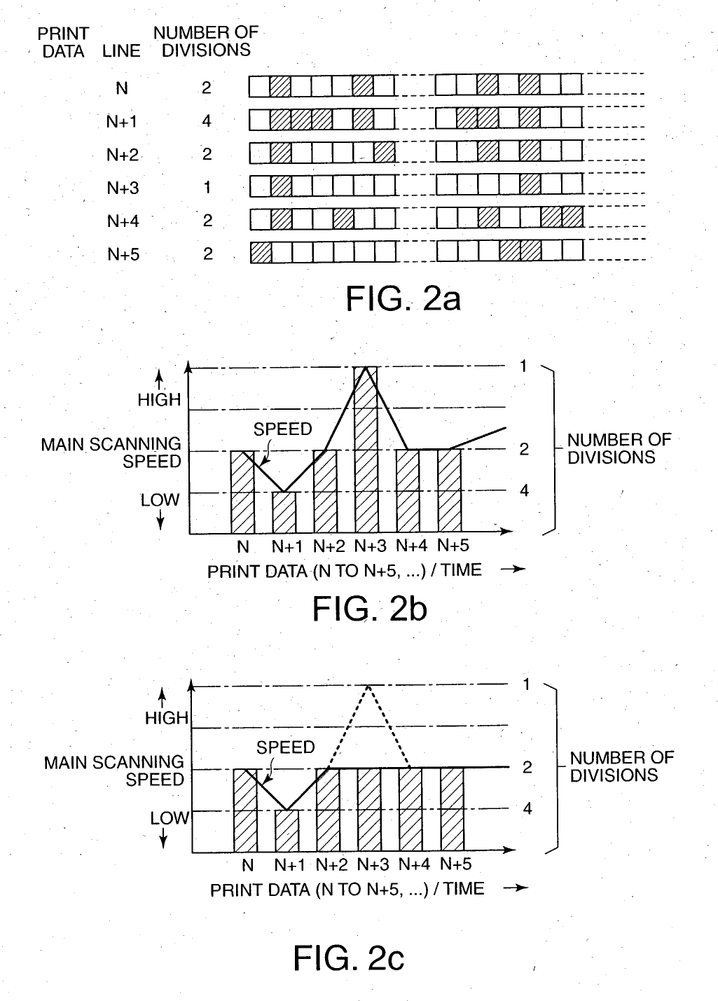

FIGS. 2a through 2c show an example of the relationship between the main scanning (i.e. paper moving) speed and the number of print element blocks on the one hand to the print dot pattern on the other hand. FIG. 2a shows part of the content stored in image buffer 16. The image buffer 16 stores image data for lines N to N+5, and the number of print element blocks for each line as determined based on the number of driven color dots in each line. FIG. 2b shows the change in the number of print element blocks and the change in the main scanning speed when levelling is not applied. FIG. 2c shows the change in the number of print element blocks and main scanning speed when levelling is applied. As it would be understood, levelling refers to reducing the change in scanning speed from one line to the next. Or stated differently, levelling refers to maintaining the change in scanning speed from one line to the next to not more than a predetermined value.

As shown in FIGS. 2a and 2b, the number of print element blocks when levelling is not applied is as follows in this example: 2 on line N, 4 on line N+1, 2 on line N+2, 1 on line N+3, 2 on line N+4, and 2 on line N+5. However as shown in FIG. 2c when levelling is applied, the number of print element blocks changes as follows: 2 on line N, 4 on line N+1, 2 on line N+2, 2 on line N+3, 2 on line N+4, and 2 on line N+5. When levelling is not applied the change in the number of print element blocks at line N+3 causes a sudden change in the main scanning speed on the lines before and after line N+3, as shown in FIG. 2b, and printing irregularities may likely result. However, by levelling the number of print element blocks through the range of lines including line N+3 as shown in FIG. 2c, sudden changes in the main scanning speed are suppressed and printing irregularities do not occur easily.

Embodiment 2

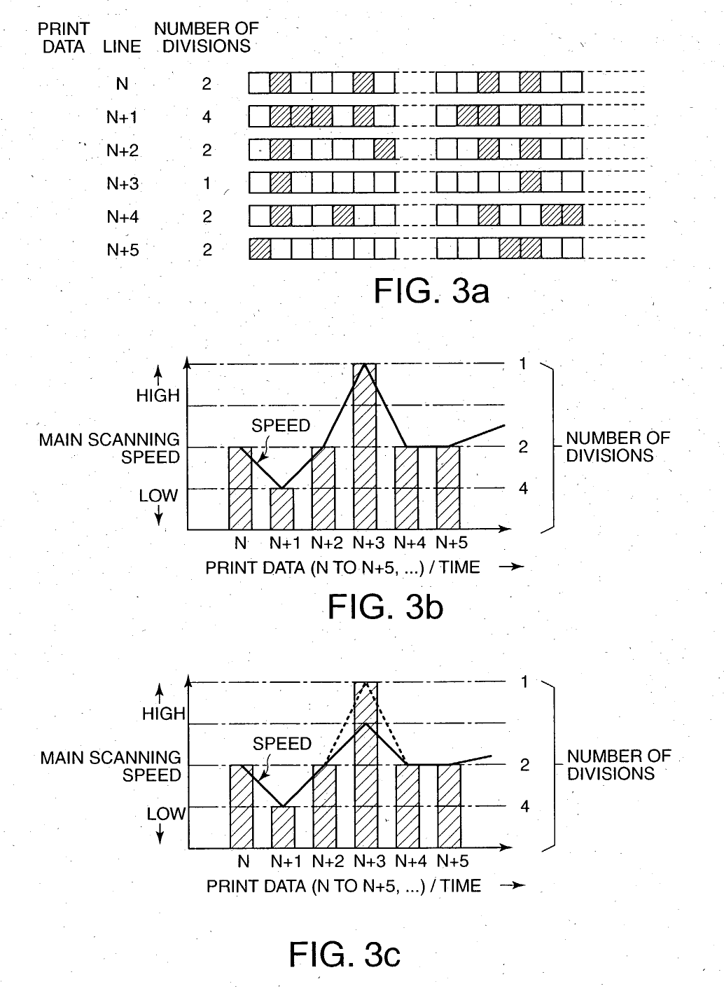

FIGS. 3a to 3c illustrate a second embodiment of the invention, and like FIGS. 2a to 2c show the relationship between the number of print element blocks and main scanning speed to the print dot pattern. A function block diagram of this second embodiment is identical to that of the first embodiment shown in FIG. 1.

Change in the main scanning speed is levelled in the above first embodiment by imposing a uniform limit on the change in the number of print element blocks. Rather than limiting the change in the number of print element blocks, however, this second embodiment prevents printing irregularities by limiting or suppressing sudden change in the main scanning speed, particularly sudden changes increasing the scanning speed.

The main scanning speed is limited according to the number of print element blocks, but within this limit it is not necessary to set the main scanning speed to the maximum speed allowed by the number of blocks. The printing speed can be optimized by variably setting the main scanning speed in conjunction with the number of print element blocks, but the overall printing speed will not drop appreciably even if the main scanning speed is set independent of the number of print element blocks when there is a sudden rise in the main scanning speed. As a result, this second embodiment of the invention can also effectively prevent printing irregularities without particularly lowering the printing speed of the printer.

In FIGS. 3a to 3c, all elements similar to those of FIGS. 2a to 2c have similar reference characters and are explained above. FIGS. 3a and 3b illustrate a similar scenario as shown in FIGS. 2a and 2c, and a description of the scenario is therefore not repeated here. In the present second embodiment as shown in FIG. 3c, however, the number of blocks in line N+3 is not changed and remains 1 (unlike in the case of the first embodiment shown in FIG. 2c where the number of blocks was increased from 1 to 2). In the present case, as illustrated by the darkened “SPEED” line indicator, the scanning speed is reduced as compared to that shown in FIG. 3b. As stated above, the SPEED line shown in FIG. 3b shows the maximum permissible speed per number of print element blocks, but in FIG. 3c the speed for line N+3 is maintained at a speed lower than the maximum permissible for 1 print element block, and therefore the difference in speed when stepping from line N+2 to line N+3 (or stepping from line N+3 to line N+4) is reduced.

It will be noted that this invention can also be applied to an inkjet printer having heat elements.

[Effects of the Invention]

By thus providing a control means for levelling the change in the main scanning speed in a printer using an in-line print head, using division driving to drive the print elements so that the drive current is equal to or below a specified level, and determining the number of print element blocks and the main scanning speed on a per line basis for printing, the maximum drive current required to drive the printing operation can be reduced without noticeably reducing the overall printing speed of the printer, and printing irregularities arising in conjunction with division driving of the print elements can be effectively reduced.

Although the present invention has been described in connection with the preferred embodiments thereof with reference to the accompanying drawings, it is to be noted that various changes and modifications will be apparent to those skilled in the art. Such changes and modifications are to be understood as included within the scope of the present invention as defined by the appended claims, unless they depart therefrom.

What is claimed is:

1. A printer having an in-line print head with multiple print elements, and effective for division driving the print elements so that drive current is not greater than a specified level, said printer comprising:
a controller for determining the number of print element blocks per printable line of print data and determining the main scanning speed per printable line of print data; wherein
said controller is further effective for maintaining a change in the main scanning speed from one printable line to the next to not greater than a predetermined value.

2. A printer as described in claim 1, wherein said controller is further effective for modifying the number of print element blocks per printable line, and said change in the main scanning speed is controlled by adjusting the number of print element blocks from one line to the next.

3. A printer as described in claim 2, wherein the number of print element blocks form one line to the next is greater than a minimum number permissible print element blocks required for optimal scanning speed.

4. A printer as described in claim 1, wherein change in the main scanning speed is controlled by temporarily independently adjusting the change in the main scanning speed within a printing speed range determined by the number of print element blocks.

5. A printer as described in claim 4, wherein the selected scanning speed within said printing speed range is lower than the maximum scanning speed available within said range.

6. A printer as described in claim 1, wherein the number of print element blocks in each line is added to plural lines of image data in an image buffer awaiting printing.
